(19) United States
(12) Patent Application Publication
(10) Pub. No.: US 2026/0329102 A1
(43) Pub. Date: Oct. 22, 2026

(54) METHOD AND SYSTEM TO TRANSFORM RANDOM POLARIZATION TO RADIAL POLARIZATION

(71) Applicant: Technology Innovation Institute - Sole Proprietorship LLC, Khalifa City (AE)

(72) Inventors: Ravi Kiran Saripalli, Abu Dhabi (AE); Mariam Alkhateri, Abu Dhabi (AE); Ramzil Galiev, Abu Dhabi (AE); Steevy Joyce Cordette, Abu Dhabi (AE); Chaouki Kasmi, Abu Dhabi (AE); Rashed AlBlooshi, Abu Dhabi (AE)

(73) Assignee: Technology Innovation Institute - Sole Proprietorship LLC, Khalifa City (AE)

(21) Appl. No.: 19/541,918

(22) Filed: Feb. 17, 2026

Related U.S. Application Data
(60) Provisional application No. 63/789,590, filed on Apr. 16, 2025.

(51) Int. Cl. G02B 27/28; B23K 26/0622

(52) U.S. Cl. CPC G02B 27/283; B23K 26/0624

(57) ABSTRACT

A passive optical filter comprising a first polarization beam splitter to separate the randomly polarized laser beam into a first beam with a first polarization and a second beam with a second polarization orthogonal to the first polarization, an optical device to convert the second beam to the first polarization and remove coherence between the first and second beams, a beam splitter to incoherently mix the first beam and the converted second beam, a waveplate to convert one of the first beam or the converted second beam to the second polarization, spiral optics to provide orbital angular momentum to the first beam and the converted second beam, a second polarization beam splitter to combine the first beam and the converted second beam, and an optical plate to convert orthogonal polarization components in the combined beam to circular polarization components which co-axially superimpose to produce the radially polarized laser beam.

### CROSS-REFERENCE TO RELATED APPLICATION

This application claims priority to U.S. Provisional Application No. 63/789,590, filed Apr. 16, 2025, which is incorporated by reference in its entirety.

### FIELD

The disclosure relates to a method and an apparatus for transforming a beam from random polarization to radial polarization.

### BACKGROUND

Fiber laser sources have become increasingly prevalent in laser manufacturing and effector applications due to their high power, efficiency, excellent beam quality, compact design, and reliability. These lasers enable precise and efficient processing of materials for cutting, welding, marking, and other industrial tasks. However, to achieve high power output, fiber sources typically cannot use polarization-maintaining fibers, resulting in randomly polarized light emission. This random polarization can lead to fluctuations in intensity and focusing behavior when the beam interacts with optical components or materials.

The random polarization output from fiber lasers presents challenges for applications requiring specific polarization states. Conventional methods for controlling polarization often involve significant light intensity losses or complex adjustments based on the input polarization state. Additionally, existing techniques for generating radially polarized beams generally rely on stable input polarization, making them unsuitable for use with randomly polarized fiber laser sources. These limitations restrict the versatility and effectiveness of fiber lasers in certain precision manufacturing and research applications where polarization control is beneficial.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, the present disclosure relates to a passive optical filter for converting a randomly polarized laser beam to a radially polarized laser beam, comprising a first polarization beam splitter to separate the randomly polarized laser beam into a first beam with a first polarization and a second beam with a second polarization orthogonal to the first polarization, an optical device to convert the second beam from the first polarization beam splitter to the first polarization and remove coherence between the second beam and the first beam, a beam splitter to incoherently mix the first beam from the first polarization beam splitter and the converted second beam from the optical device, a waveplate to convert one of the first beam from the beam splitter or the converted second beam from the beam splitter to the second polarization, spiral optics to provide orbital angular momentum to the first beam from the beam splitter and the converted second beam from the waveplate, a second polarization beam splitter to combine the first beam from the spiral optics and the converted second beam from the spiral optics to a combined beam, and an optical plate to convert orthogonal polarization components in the combined beam to circular polarization components which co-axially superimpose to produce the radially polarized laser beam.

In embodiments of this aspect, the disclosure according to any one of the above example embodiments, the optical device comprises a beam converter and at least one mirror mounted on a delay stage configured to ensure a path length difference between the first beam and the converted second beam exceeds a coherence length of the randomly polarized laser beam.

In embodiments of this aspect, the disclosure according to any one of the above example embodiments, the spiral optics comprise a first spiral phase plate receiving the first beam from the beam splitter, and a second spiral phase plate receiving the converted second beam from the waveplate.

In embodiments of this aspect, the disclosure according to any one of the above example embodiments, the first spiral phase plate has a topological charge of +1 and the second spiral phase plate has a topological charge of −1.

In embodiments of this aspect, the disclosure according to any one of the above example embodiments, the waveplate is a half-wave plate.

In embodiments of this aspect, the disclosure according to any one of the above example embodiments, the first polarization is horizontal polarization.

In embodiments of this aspect, the disclosure according to any one of the above example embodiments, the beam splitter is a 50:50 beam splitter configured to produce two output beams of equal intensity.

In one aspect, the present disclosure relates to a method for converting a randomly polarized laser beam to a radially polarized laser beam using a passive optical filter, comprising separating the randomly polarized laser beam into a first beam with a first polarization and a second beam with a second polarization orthogonal to the first polarization, converting the second beam to the first polarization and removing coherence between the second beam and the first beam, incoherently mixing the first beam and the converted second beam, converting one of the first beam or the converted second beam to the second polarization, providing orbital angular momentum to the first beam and the converted second beam, combining the first beam and the converted second beam to a combined beam, and converting orthogonal polarization components in the combined beam to circular polarization components which co-axially superimpose to produce the radially polarized laser beam.

In embodiments of this aspect, the disclosure according to any one of the above example embodiments, removing the coherence between the second beam and the first beam by directing the second beam along a path comprising a beam converter and at least one mirror mounted on a delay stage, the path having a length difference that exceeds a coherence length of the randomly polarized laser beam.

In embodiments of this aspect, the disclosure according to any one of the above example embodiments, the providing the orbital angular momentum further comprises directing the first beam to a first spiral phase plate, and directing the second converted beam to a second spiral phase plate.

In embodiments of this aspect, the disclosure according to any one of the above example embodiments, imparting by the first spiral phase plate a topological charge of +1 on the first beam, and imparting by the second spiral phase plate a topological charge of −1 on the second converted beam.

In embodiments of this aspect, the disclosure according to any one of the above example embodiments, converting, by a half-waveplate, one of the first beam or the converted second beam to the second polarization.

In embodiments of this aspect, the disclosure according to any one of the above example embodiments, the first polarization is a horizontal polarization.

In embodiments of this aspect, the disclosure according to any one of the above example embodiments, mixing the first beam and the converted second beam using a 50:50 beam splitter.

In one aspect, the present disclosure relates to a system for generating a radially polarized laser beam, comprising a laser to emit a randomly polarized laser beam, collimating optics to collimate the randomly polarized laser beam, a passive optical filter comprising a first polarization beam splitter to separate the randomly polarized laser beam into a first beam with a first polarization and a second beam with a second polarization orthogonal to the first polarization, an optical device to convert the second beam from the first polarization beam splitter to the first polarization and remove coherence between the second beam and the first beam, a beam splitter to incoherently mix the first beam from the first polarization beam splitter and the converted second beam from the optical device, a waveplate to convert one of the first beam from the beam splitter or the converted second beam from the beam splitter to the second polarization, spiral optics to provide orbital angular momentum to the first beam from the beam splitter and the converted second beam from the waveplate, a second polarization beam splitter to combine the first beam from the spiral optics and the converted second beam from the spiral optics to a combined beam, and an optical plate to convert orthogonal polarization components in the combined beam to circular polarization components which co-axially superimpose to produce the radially polarized laser beam, and focusing optics to focus the radially polarized laser beam.

In embodiments of this aspect, the disclosure according to any one of the above example embodiments, the optical device of the passive optical filter comprises a beam converter and at least one mirror mounted on a delay stage configured to ensure a path length difference between the first beam and the converted second beam exceeds a coherence length of the randomly polarized laser beam.

In embodiments of this aspect, the disclosure according to any one of the above example embodiments, the spiral optics of the passive optical filter comprise a first spiral phase plate receiving the first beam from the beam splitter, and a second spiral phase plate receiving the second converted beam from the waveplate.

In embodiments of this aspect, the disclosure according to any one of the above example embodiments, the first spiral phase plate has a topological charge of +1 and the second spiral phase plate has a topological charge of −1.

In embodiments of this aspect, the disclosure according to any one of the above example embodiments, the waveplate of the passive optical filter is a half-wave plate, the first polarization is horizontal polarization.

In embodiments of this aspect, the disclosure according to any one of the above example embodiments, the beam splitter of the passive optical filter is a 50:50 beam splitter configured to produce two output beams of equal intensity.

### BRIEF DESCRIPTION OF THE DRAWINGS

So that the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1A illustrates a block diagram of a system for processing a workpiece using a laser beam, according to aspects of the present disclosure.

FIG. 1B illustrates a block diagram of the optics in FIG. 1A, according to aspects of the present disclosure.

FIG. 2A illustrates a comparison between linear polarization and radial polarization in optical systems, according to aspects of the present disclosure.

FIG. 2B illustrates a diagram showing the generation of a radially polarized beam, according to aspects of the present disclosure.

FIG. 3A illustrates a block diagram of an optical system for converting a randomly polarized laser beam to a radially polarized laser beam, according to aspects of the present disclosure.

FIG. 3B illustrates another block diagram of an optical system for converting a randomly polarized laser beam to a radially polarized laser beam, according to aspects of the present disclosure.

FIG. 4A illustrates a flowchart of a method for converting a randomly polarized laser beam to a radially polarized laser beam, according to aspects of the present disclosure.

FIG. 4B illustrates another flowchart of a method for converting a randomly polarized laser beam to a radially polarized laser beam, according to aspects of the present disclosure.

FIG. 4C illustrates a further flowchart of a method for converting a randomly polarized laser beam to a radially polarized laser beam, according to aspects of the present disclosure.

### DETAILED DESCRIPTION

The present disclosure relates to a system and method for converting randomly polarized laser beams to radially polarized laser beams. The system may include a passive optical filter that efficiently transforms the polarization state of an input laser beam without significant power loss. In some cases, the system may be configured to work with various laser sources, including fiber laser sources that generate randomly polarized output.

The system for converting randomly polarized laser beams to radially polarized laser beams may offer several benefits. The passive nature of the optical filter may allow for stable and consistent performance without the need for active control or feedback mechanisms. Additionally, the system may maintain high power efficiency, preserving the intensity of the input beam throughout the conversion process. The ability to generate radially polarized beams from randomly polarized sources may expand the capabilities of existing laser systems without requiring changes to the laser source itself.

The applications for this polarization conversion system may be diverse and span multiple industries. In manufacturing, the system may be utilized for laser marking, laser cutting, laser welding, and laser drilling applications. The radially polarized output may provide improved focusing characteristics and more uniform energy distribution, potentially enhancing the precision and efficiency of these processes. In the field of defense, the system may be applied to counter-measure lasers, where precise control of beam properties may be beneficial.

In scientific research, the polarization conversion system may find applications in optical tweezers, where radially polarized beams may offer enhanced trapping capabilities for manipulating microscopic particles. The system may also be beneficial in high-resolution imaging applications, where the properties of radially polarized light may lead to improved resolution and contrast.

The versatility of the system may allow for its integration into various existing laser setups. In some cases, the system may be particularly well-suited for use with fiber laser sources, which are known for their high-power output and efficiency but often produce randomly polarized beams. By converting this random polarization to a radial polarization, the system may unlock new capabilities for fiber lasers in applications that benefit from or require radially polarized light.

In other words, the system for converting randomly polarized laser beams to radially polarized laser beams may offer a flexible and efficient solution for a wide range of laser applications. The passive optical filter at the core of the system may provide a robust method for polarization conversion, potentially expanding the utility of existing laser sources and enabling new possibilities in fields ranging from industrial manufacturing to scientific research.

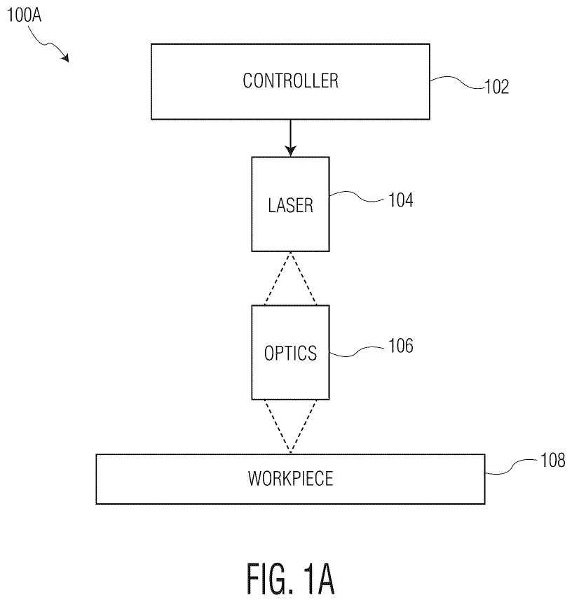

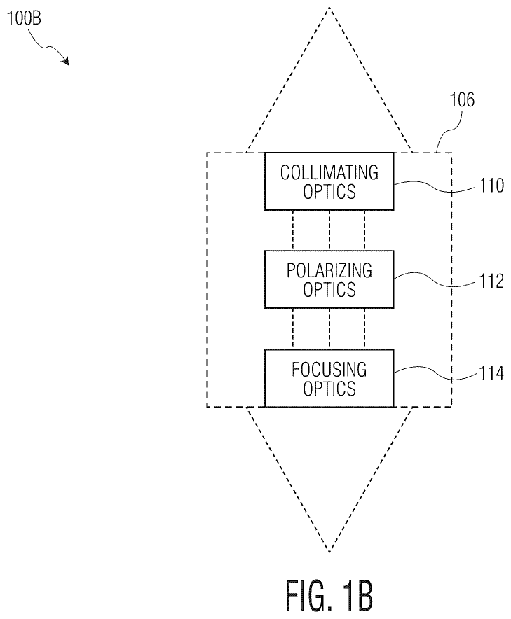

FIG. 1A illustrates a block diagram of a system 100A for processing a workpiece using a laser beam. The system 100A may include a controller 102, a laser 104, optics 106, and a workpiece 108. The controller 102 may be connected to the laser 104, which may be optically coupled to the optics 106. The optics 106 may be positioned to direct the laser beam onto the workpiece 108. The workpiece 108 may be a target material or object that is being processed by the laser beam, such as a metal sheet for cutting or a semiconductor wafer for etching, etc., and is not considered part of the optical system itself but rather the end recipient of the processed laser beam.

In operation, the controller 102 may provide control signals to the laser 104 to generate the laser beam. The laser 104 may output the laser beam through the optics 106, which may modify and direct the beam. The optics 106 may be arranged between the laser 104 and the workpiece 108 to process the workpiece 108 with the modified laser beam.

FIG. 1B illustrates a block diagram of an optical system 100B including a more detailed view of the optics 106 shown in FIG. 1A. The optical system 100B may include collimating optics 110, polarizing optics 112, and focusing optics 114, arranged in an optical path within 106.

The collimating optics 110 may be positioned to receive an input beam and collimate the beam. The polarizing optics 112 may be positioned downstream of the collimating optics 110 to process the collimated beam. The focusing optics 114 may be positioned downstream of the polarizing optics 112 to focus the processed beam.

As mentioned above, the laser 104 may emit a randomly polarized laser beam. The collimating optics 110 may collimate this polarized laser beam. The polarizing optics 112 are a passive optical filter configured to convert the randomly polarized laser beam into a radially polarized laser beam. The focusing optics 114 may then focus the radially polarized laser beam onto the workpiece 108.

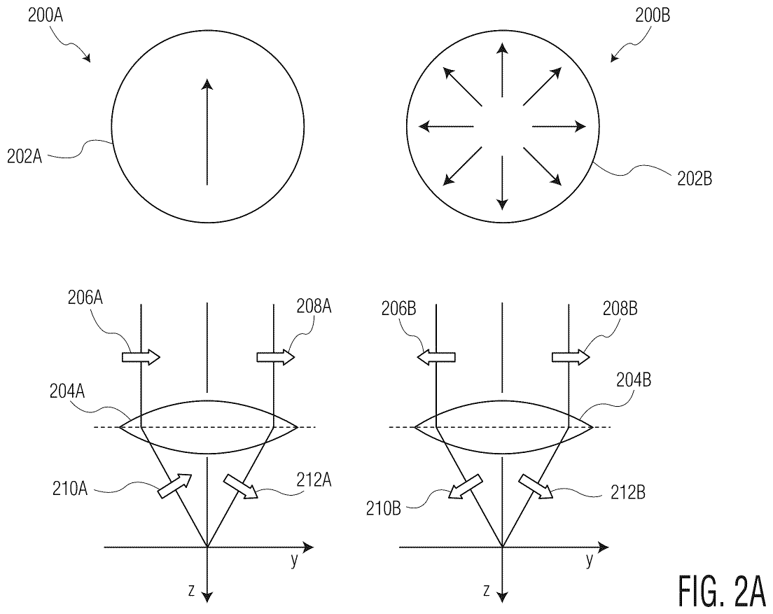

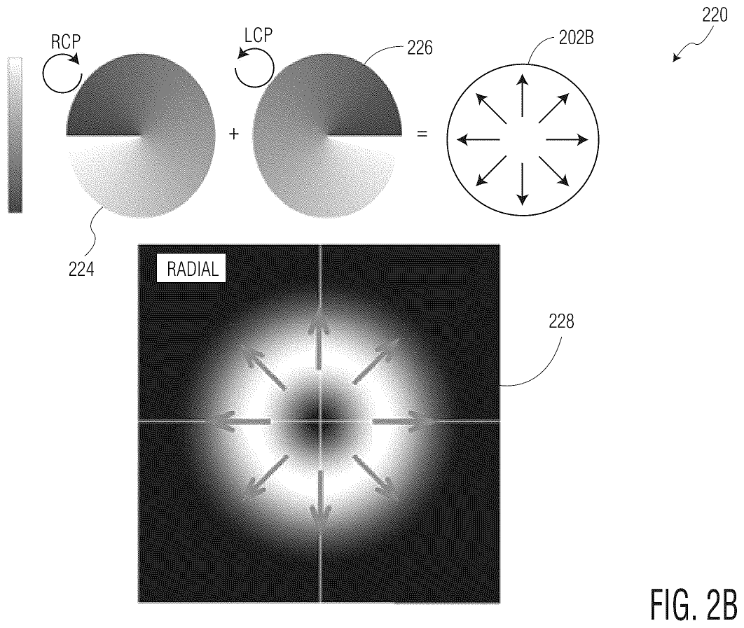

Before discussing further details of the system, it is worth reviewing the characteristics of polarized beams. FIG. 2A illustrates a comparison between a linear polarization 200A and radial polarization 200B in optical systems. The figure shows two side-by-side diagrams depicting different polarization states and their focusing characteristics.

In the left diagram, a linear beam 202A with linear polarization 200A passes through focusing optics 204A. The linear beam 202A exhibits a single linear field direction 206A, 208A, 210A, 212A represented by an arrow within the beam 202A. This uniform field direction is characteristic of linearly polarized light, where the electric field oscillates in a single plane.

In a randomly polarized beam, the electric field vector oscillates in various directions perpendicular to the direction of propagation, with these directions changing rapidly and unpredictably over time. The beam may be considered as a superposition of many different linear polarization states, each with a random orientation and phase. As the beam propagates, these different linear states interfere and combine, resulting in a constantly fluctuating polarization state. At any given instant, the beam may appear to have a specific linear polarization, but this state quickly evolves into another random orientation. This continuous variation in polarization direction occurs on timescales typically faster than other detection systems can resolve, leading to the perception of an overall unpolarized or randomly polarized beam when observed over longer time periods.

In contrast, the right diagram shows a radial beam 202B with radial polarization 200B passing through focusing optics 204B. The radial beam 202B exhibits multiple radial field directions 206B, 208B, 210B, 212B represented by arrows pointing outward from the center of the beam 202B, forming a radial pattern. This radial field distribution is a beneficial feature of radially polarized light, where the electric field points radially outward from the beam axis.

As mentioned above, the radially oriented electric field vectors in a radially polarized beam may offer several advantages in various applications. This configuration may allow for tighter focusing of the beam, potentially achieving spot sizes smaller than those possible with linearly polarized light. When focused, the radial polarization may create a strong longitudinal field component at the focal point, which may be beneficial for applications such as particle trapping, high-resolution microscopy, and material processing. Additionally, the symmetrical nature of radial polarization may result in more uniform energy distribution and absorption characteristics when interacting with materials or structures, potentially improving the efficiency and precision of processes like laser cutting, drilling, or surface modification.

The focusing optics 204A, 204B are shown directing the respective beams downward. A dashed line appears across each beam path, indicating the plane where the focusing effects may be observed. The arrows below these dashed lines illustrate how the respective polarization states may manifest in the focal region. In some cases, the first polarization may be horizontal polarization. This horizontal polarization may correspond to the linear polarization 200A shown in the left diagram of FIG. 2A.

FIG. 2B illustrates a diagram 220 showing the generation of a radially polarized beam by the combination of two polarization states (i.e. components) within the same beam. Specifically, the diagram shows a right circular polarization (RCP) 224 and a left circular polarization (LCP) 226 components within the same beam being combined to generate a radial beam 202B. The RCP 224 and LCP 226 components may be represented as circular discs with gradient shading patterns indicating their respective polarization states.

When the RCP 224 and LCP 226 components are combined, they co-axially superimpose to produce a radially polarized beam 228. The radially polarized beam 228 may exhibit a characteristic intensity distribution with arrows indicating the radial polarization pattern emanating from the center of the beam.

In some cases, an optical plate may be used to convert the combined first beam and second converted beam to circular polarization components which co-axially superimpose to produce the radially polarized laser beam. This process may be represented by the combination of RCP 224 and LCP 226 to form the radially polarized beam 228 as shown in FIG. 2B.

The diagram shows a grayscale intensity bar on the left side to indicate the relative intensity levels in the beam patterns. The radial beam 202B may be depicted with outward-pointing arrows arranged in a circular pattern, representing the radial polarization state of the output beam.

Coaxial superimposition may refer to the process of overlapping two or more beams of light along the same optical axis. When beams are coaxially superimposed, they may propagate in the same direction and occupy the same spatial region. This alignment may allow for the interaction and interference of the beams' properties, such as their polarization states or phase characteristics. In the case of generating radially polarized light, the coaxial superimposition of right and left circularly polarized components with specific phase relationships result in the creation of a radially polarized beam pattern. This technique may enable the manipulation of complex polarization states and beam profiles for various applications in optics and photonics.

The following text describes some example configurations of the optical filter system designed for converting randomly polarized laser beams to radially polarized beams. These configurations may illustrate various arrangements of optical components and their interactions to achieve the desired polarization transformation. By examining these specific implementations, we may gain insights into the practical aspects of the conversion process, the roles of different optical elements, and how they work together to produce a radially polarized output beam.

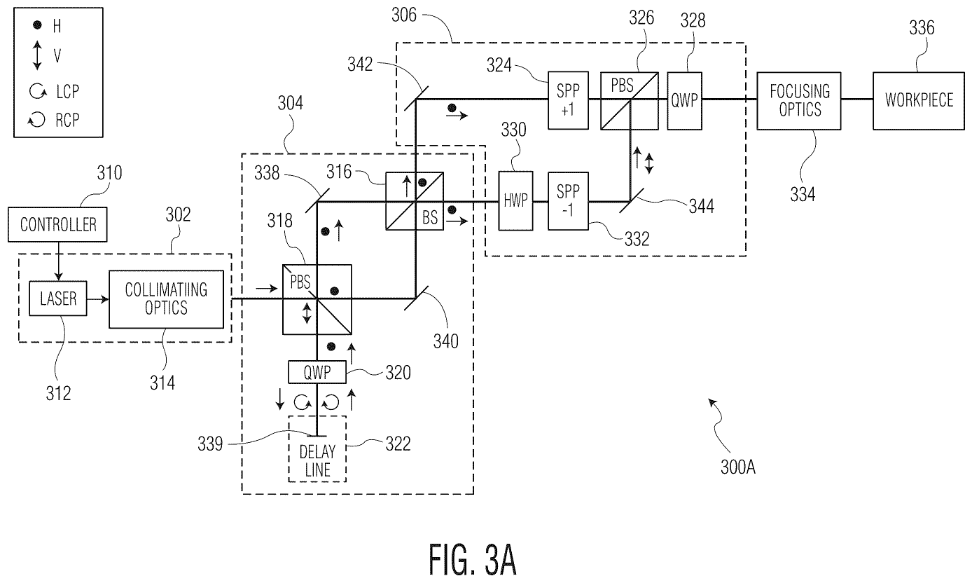

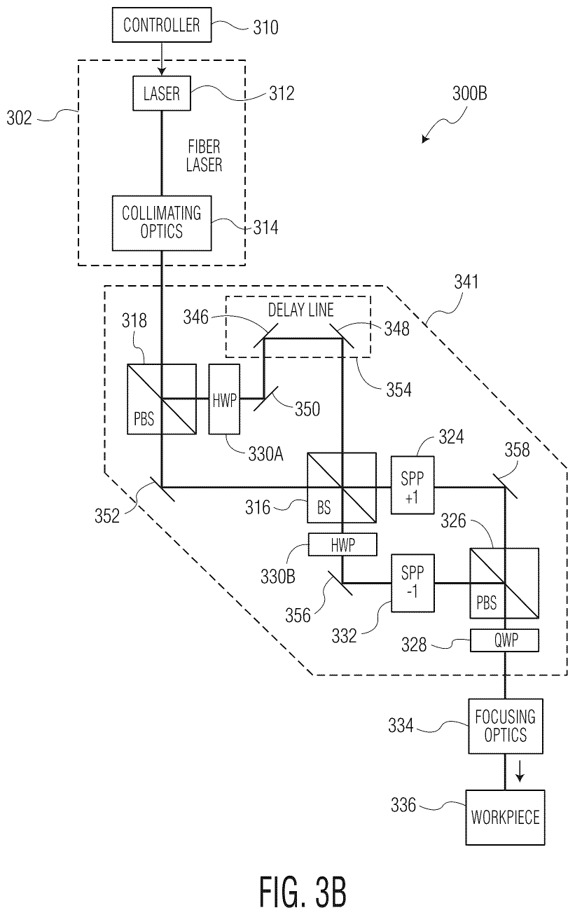

More specifically, in the optical systems depicted in FIG. 3A and FIG. 3B, a series of optical components are configured to convert randomly polarized laser beams into radially polarized beams. These systems, referred to as optical system 300A and optical system 300B, respectively, incorporate various modules and elements that work in concert to achieve the desired polarization transformation.

In the context of FIG. 3A, optical system 300A may include controller 310, source optics 302 including laser 312 and collimating optics 314, polarizing optics 304 and 306, focusing optics 334 and workpiece 336. Polarizing optics 304 and 306 may include a polarization beam splitter (PBS) 318, a quarter wave plate (QWP) 320, a delay line 322, mirrors 338 and 340, a beam splitter (BS) 316, mirrors 342 and 344, a half wave plate (HWP) 330, spiral phase plates (SPPs) 332 and 324, a second PBS 326, and a QWP 328.

In operation the beam encounters a PBS 318, which separates the beam into two orthogonal polarization states: horizontal (H) and vertical (V). The H-polarized beam passes directly through PBS 318 and is directed towards the beam splitter 316 via mirror 340, while the V-polarized beam is reflected towards a QWP 320. This QWP 320 converts the V-polarized beam into circular polarization, which, after reflection from a mirror 339 and passing back through QWP 320, becomes H-polarized. This converted beam then re-enters PBS 318 and is directed towards BS 316 via mirror 338.

BS 316 may be a 50:50 BS that incoherently mixes the two H-polarized beams due to coherence being removed by delay line 322. The delay line 322 may be adjustable to ensure that the path length difference between the beams exceeds the coherence length of the laser, thus preventing any interference patterns that may arise from phase correlations. In other words, rather than producing a single merged beam, BS 316 creates two separate output paths. Each of these output paths contains a mixture of the original input beams. This configuration allows the system to benefit from the combined properties of the input beams while maintaining the ability to process two distinct beams in subsequent stages of the polarization conversion process.

Following the recombination, one of the H-polarized beams is directed by mirror 342 to SPP 324. Prior to entering SPP 332, the other one of the H-polarized beams is converted to vertical polarization by horizontal wave plate 330. Each SPP imparts a specific orbital angular momentum to the respective beam; SPP 332 imparts a topological charge of −1 on the vertical beam before being directed by mirror 344 to a second PBS 326, and SPP 324 imparts a topological charge of +1 on the horizontal beam which is then directed to the second PBS 326. These charged beams are combined in the second PBS 326. This combination sets up the interference pattern for radial polarization. The combined beam then passes through a QWP 328, which converts the orthogonal linear polarization components to circular polarization components. These circular polarization components coaxially superimpose to form a beam with radial polarization. This radially polarized beam is directed towards focusing optics 334, which focuses the beam onto a workpiece 336.

More specifically, the recombined beam passes through a QWP to transform the horizontal (H) and vertical (V) polarization components into right and left circular polarization components. The QWP may introduce a phase shift between the orthogonal components of the beam, effectively converting linear polarization components to circular polarization components. When these circularly polarized components coaxially superimpose, they may interfere in a way that produces the desired radial polarization pattern across the beam profile.

The interaction between the right and left circular polarization components and the spiral phase imparted by the SPPs are beneficial to creating the radial polarization distribution. As the beams interfere, they may generate a varying polarization state across the beam's cross-section. At each point, the superposition of the two beams may result in a linear polarization, but the orientation of this polarization may depend on the azimuthal position within the beam. This variation may occur because the SPPs may introduce an azimuthally varying phase to each beam with opposite polarity, and the right and left circular polarization components may have opposite handedness. The resulting polarization state at any given point may be determined by the relative phase difference between the two beams at that location. Consequently, the polarization direction may rotate around the beam axis, consistently pointing radially outward from the center. At the beam's center, where the phase may be undefined, a characteristic dark spot or “doughnut” intensity profile may form. By adjusting parameters such as the QWP orientation and the topological charges of the SPPs, this interference process may be fine-tuned to generate various vector beam profiles, with radial polarization being one possible outcome.

Optical system 300B in FIG. 3B functions similarly to optical system 300A but includes variations in the configuration of the delay line and the arrangement of the mirrors and wave plates. Specifically, system 300B includes controller 310, source optics 302 including laser 312 and collimating optics 314, polarizing optics 341, focusing optics 334 and workpiece 336. Polarizing optics 341 in FIG. 3B may include a PBS 318, HWP plates 330A and 330B, BS 316, mirrors 350, 352, 356, and 358, delay line 354 with mirrors 346 and 348, SPPs 324 and 332, PBS 326, and QWP 328. The workpiece 336 may be a target material or object that is being processed by the laser beam, such as a metal sheet for cutting or a semiconductor wafer for etching, etc., and is not considered part of the optical system itself but rather the end recipient of the processed laser beam.

In this system, the randomly polarized beam from laser 312 is split by PBS 318 into H and V polarized beams. The V polarized beam is converted to H polarized beam using a HWP 330A before being reflected by mirror 350 into a delay line 354, which includes additional mirrors 346 and 348 to ensure the path length difference is sufficient to remove coherence before entering the BS 316. The H beam passing through PBS 318 is reflected by mirror 352 such that the H beam reflected from mirror 352 and the H beam exiting the delay line recombine at BS 316 which creates two separate output paths containing a mixture of the original input beams and are processed through SPPs 324 and 332, similarly to optical system 300A. More specifically, the H beam exiting BS 316 may be converted to a V beam by half-wave plate 330B and reflected via mirror 356 into SPP 332. Meanwhile, the H beam exiting BS 316 may be input directly to SPP 324 and reflected by mirror 358 into PBS 326. The beams may then be combined by PBS 326 and QWP 328 as in system 300A to create the radially polarized beam. This configuration may allow for the polarization transformations and phase modifications to generate the desired radially polarized output.

While the detailed descriptions of optical systems 300A and 300B provide specific configurations, variations in these setups are possible to accommodate different types of lasers, beam characteristics, or specific application requirements. For instance, the types of wave plates, the arrangement of the mirrors, or the characteristics of the BSs can be adjusted to optimize the performance for specific polarization conversion tasks.

It is also noted that the delay lines in FIG. 3A and FIG. 3B may be adjusted through various mechanisms to ensure effective coherence removal between the beam paths. In some implementations, the mirrors may be manually set for a given laser setup. In other examples, the mirrors may be automatically adjustable via adjustable mirror mounts (e.g. piezoelectric, etc.) potentially allowing for both coarse and fine adjustments of the beam path for setups and differing applications.

Described below are methods that generally follow the functionality of the optical systems described above to convert randomly polarized laser beams into radially polarized beams. These methods may outline the step-by-step processes involved in manipulating the beam's polarization state, providing a comprehensive understanding of the conversion techniques utilized in the systems described above.

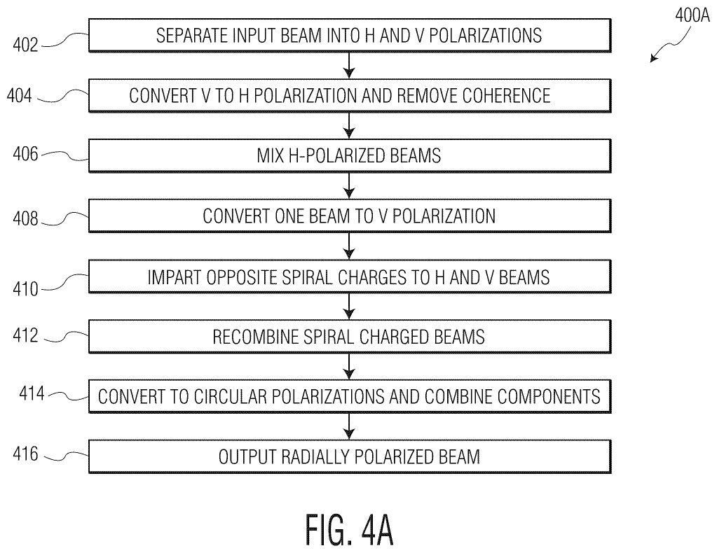

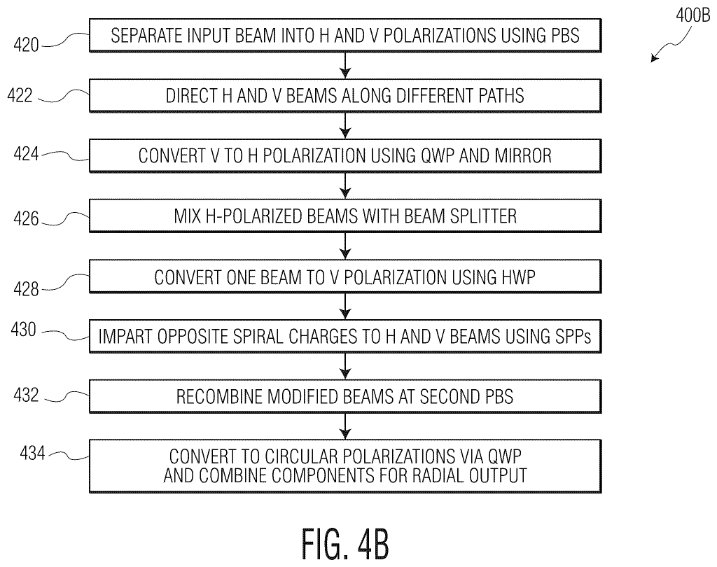

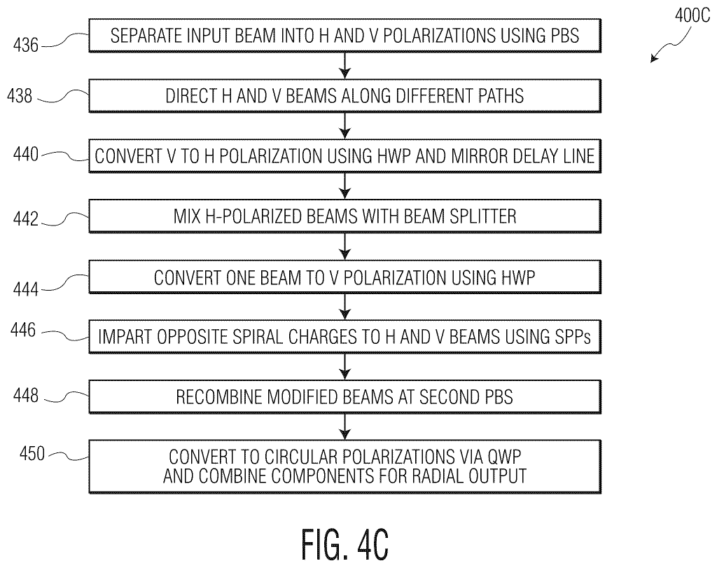

FIG. 4A illustrates an overall method 400A for converting a randomly polarized laser beam to a radially polarized laser beam.

The method 400A may include the steps of: (402) separating an input beam into H and V polarized beams, (404) converting V polarized beam to H polarized beam and removing coherence, (406) recombining H-polarized beams, (408) converting one beam to V polarization, (410) imparting opposite spiral charges to H and V beams, (412) recombining spiral charged beams, (414) converting beams to orthogonal circular polarization components, and (416) outputting a radially polarized beam.

The method 400A may include a step 402 of separating an input beam into horizontal (H) and vertical (V) polarizations. In a step 404, the method 400A may convert the V polarized beam to H polarized beam and remove coherence between the beams. In some cases, removing the coherence between the second beam and the first beam may be accomplished by directing the second beam along a path comprising a beam converter and at least one mirror mounted on a delay stage. The path may have a length difference that exceeds a coherence length of the randomly polarized laser beam. This approach may ensure that the beams are combined incoherently in subsequent steps.

The method 400A may proceed to a step 406 where the H-polarized beams are recombined. In some implementations, a 50:50 BS may be used for recombining the beams. As mentioned above, rather than producing a single merged beam, 50:50 BS creates two separate output beams of equal intensity.

In a step 408, the method 400A may convert one beam to V polarization. This conversion may be accomplished using a half-waveplate to convert one of the beams to the second polarization.

Steps 410 of the method 400A may involve imparting opposite spiral charges to the H and V beams. In some cases, this may be achieved by directing the first beam to a first SPP and directing the second converted beam to a second SPP. The first SPP may impart a topological charge of +1 on the first beam, while the second SPP may impart a topological charge of −1 on the second converted beam.

The method 400A continues with step 412, where the spiral charged beams are recombined at a polarization beam splitter, producing a single beam with orthogonal linear polarization components. In step 414, this recombined beam passes through a quarter-wave plate, converting the orthogonal linear polarizations to right and left circular polarization components within the same beam. In step 416, the method 400A outputs a radially polarized beam, formed by the interference of these circular polarization components, for various applications.

FIG. 4B depicts a method 400B which may provide a method for converting a randomly polarized laser beam to a radially polarized laser beam according to the optical configuration shown in FIG. 3A.

The method 400B may include the steps of: (420) separating an input beam into H and V polarized beams using a PBS, (422) directing H and V beams along different paths, (424) converting V polarized beam to H polarized beam using a QWP and mirror, (426) recombining H-polarized beams with a BS, (428) converting one beam to V polarization using a HWP, (430) imparting opposite spiral charges to H and V beams using SPPs, (432) recombining modified beams at a second PBS, and (434) converting beams to circular polarization components via a QWP and combining them to produce a radial output.

The method 400B may begin with a step 420 of separating an input beam into H and V polarized beams using a PBS. In a step 422, the method 400B may direct the H and V beams along different paths.

A step 424 of the method 400B may convert the V polarized beam to H polarized beam using a QWP and mirror. Following this, a step 426 may involve recombining the H-polarized beams with a BS. In some implementations, a 50:50 BS may be used. As mentioned above, rather than producing a single merged beam, the 50:50 BS creates two separate output beams of equal intensity.

The method 400B may continue with a step 428 where one beam is converted to V polarization using a HWP. In a step 430, the method 400B may impart opposite spiral charges to the H and V beams using SPPs. The first SPP may impart a topological charge of +1 on the first beam, while the second SPP may impart a topological charge of −1 on the second beam.

Step 432 of the method 400B involves recombining the modified beams at a second PBS, producing a single beam with orthogonal linear polarization components. The method 400B then proceeds to step 434, where this recombined beam passes through a QWP. The QWP converts the orthogonal linear polarizations within the beam to right and left circular polarization components. These circular polarization components interfere within the beam to produce the final radially polarized output.

FIG. 4C illustrates a method 400C which may provide a method for converting a randomly polarized laser beam to a radially polarized laser beam according to the optical configuration shown in FIG. 3B.

The method 400C may include the steps of: (436) separating an input beam into H and V polarized beams using a PBS, (438) directing H and V beams along different paths, (440) converting V polarized beam to H polarized beam using a HWP and mirror delay line, (442) recombining H-polarized beams using a BS, (444) converting one beam to V polarization using a HWP, (446) imparting opposite spiral charges to H and V beams using SPPs, (448) recombining modified beams at a second PBS, and (450) converting beams to circular polarization components via a QWP and combining them to produce a radial output.

The method 400C may begin with a step 436 of separating an input beam into H and V polarized beams using a PBS. In a step 438, the method 400C may direct the H and V beams along different paths.

A step 440 of the method 400C may convert the V polarized beam to H polarized beam using a half-wave plate (HWP) and mirror delay line. The mirror delay line may be configured to ensure a path length difference between the first beam and the converted second beam exceeds a coherence length of the randomly polarized laser beam. This approach may remove coherence between the beams.

The method 400C may then proceed to a step 442 where the H-polarized beams are recombined using a BS. In some implementations, a 50:50 BS may be used. As mentioned above, rather than producing a single merged beam, the 50:50 BS creates two separate output beams of equal intensity.

A step 444 of the method 400C may involve converting one beam to V polarization using a HWP. The method 400C may continue with a step 446 where opposite spiral charges are imparted to the H and V beams using SPPs. The first SPP may impart a topological charge of +1 on the first beam, while the second SPP may impart a topological charge of −1 on the second converted beam.

In step 448, the method 400C recombines the modified beams at a second PBS, producing a single beam with orthogonal linear polarization components. The method 400C then proceeds to step 450, where this recombined beam passes through a QWP. The QWP converts the orthogonal linear polarizations within the beam to right and left circular polarization components. These circular polarization components interfere within the beam to produce the final radially polarized output.

The methods described above may provide different approaches to achieving the conversion from randomly polarized laser beams to radially polarized laser beams, each with potential advantages depending on the specific application or implementation requirements.

In some cases, variations to the described examples may be possible. The specific components and configurations of the passive optical filter system may be modified while still achieving the conversion of randomly polarized laser beams to radially polarized laser beams. For example, the types of optical elements used, such as waveplates, BSs, and PBSs, may be substituted with functionally equivalent components that perform similar polarization manipulations.

The arrangement and positioning of optical components within the system may also be adjusted. In some implementations, additional optical elements like mirrors or lenses may be incorporated to modify beam paths or characteristics. The specific design of the delay line used for coherence removal may vary, potentially utilizing different configurations of mirrors or other delay mechanisms to achieve the desired path length difference.

The SPPs used to impart orbital angular momentum may have different topological charge values in some variations, allowing for the generation of alternative vector beam profiles. The method of combining the modified beams to produce the radially polarized output may also be adapted, potentially using different interference or superposition techniques.

In some cases, the system may be scaled or miniaturized for integration into various laser-based devices or applications. The specific wavelengths and power levels of the input laser beams may vary depending on the intended use, with the optical components selected or adjusted accordingly to maintain performance across different operating conditions.

The passive optical filter system for converting randomly polarized laser beams to radially polarized laser beams may provide several potential benefits. The system may allow for efficient polarization conversion without significant power loss, which may be advantageous in high-power laser applications. The passive nature of the system may offer stability and reliability, potentially eliminating the need for active control or feedback mechanisms.

In other words, the disclosed passive optical filter system for converting randomly polarized laser beams to radially polarized laser beams may offer a versatile and efficient solution for generating specialized beam profiles. The system's ability to handle input beams with fluctuating polarization states may make it suitable for a wide range of laser sources and applications. As laser technology continues to advance, this polarization conversion technique may enable new capabilities in fields such as manufacturing, scientific research, and advanced imaging.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the presented example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A passive optical filter for converting a randomly polarized laser beam to a radially polarized laser beam, comprising:
a first polarization beam splitter to separate the randomly polarized laser beam into a first beam with a first polarization and a second beam with a second polarization orthogonal to the first polarization;
an optical device to convert the second beam from the first polarization beam splitter to the first polarization and remove coherence between the second beam and the first beam;
a beam splitter to incoherently mix the first beam from the first polarization beam splitter and the converted second beam from the optical device;
a waveplate to convert one of the first beam from the beam splitter or the converted second beam from the beam splitter to the second polarization;
spiral optics to provide orbital angular momentum to the first beam from the beam splitter and the converted second beam from the waveplate;
a second polarization beam splitter to combine the first beam from the spiral optics and the converted second beam from the spiral optics to a combined beam; and
an optical plate to convert orthogonal polarization components in the combined beam to circular polarization components which co-axially superimpose to produce the radially polarized laser beam.

2. The passive optical filter of claim 1, wherein the optical device comprises a beam converter and at least one mirror mounted on a delay stage configured to ensure a path length difference between the first beam and the converted second beam exceeds a coherence length of the randomly polarized laser beam.

3. The passive optical filter of claim 1, wherein the spiral optics comprise:
a first spiral phase plate receiving the first beam from the beam splitter; and
a second spiral phase plate receiving the converted second beam from the waveplate.

4. The passive optical filter of claim 3, wherein the first spiral phase plate has a topological charge of +1 and the second spiral phase plate has a topological charge of −1.

5. The passive optical filter of claim 1, wherein the waveplate is a half-wave plate.

6. The passive optical filter of claim 1, wherein the first polarization is horizontal polarization.

7. The passive optical filter of claim 1, wherein the beam splitter is a 50:50 beam splitter configured to produce two output beams of equal intensity.

8. A method for converting a randomly polarized laser beam to a radially polarized laser beam using a passive optical filter, comprising:
separating the randomly polarized laser beam into a first beam with a first polarization and a second beam with a second polarization orthogonal to the first polarization;
converting the second beam to the first polarization and removing coherence between the second beam and the first beam;
incoherently mixing the first beam and the converted second beam;
converting one of the first beam or the converted second beam to the second polarization;
providing orbital angular momentum to the first beam and the converted second beam;
combining the first beam and the converted second beam to a combined beam; and
converting orthogonal polarization components in the combined beam to circular polarization components which co-axially superimpose to produce the radially polarized laser beam.

9. The method of claim 8, further comprising:
removing the coherence between the second beam and the first beam by directing the second beam along a path comprising a beam converter and at least one mirror mounted on a delay stage, the path having a length difference that exceeds a coherence length of the randomly polarized laser beam.

10. The method of claim 8, wherein the providing the orbital angular momentum further comprises:
directing the first beam to a first spiral phase plate; and
directing the second converted beam to a second spiral phase plate.

11. The method of claim 10, further comprising:
imparting by the first spiral phase plate a topological charge of +1 on the first beam; and
imparting by the second spiral phase plate a topological charge of −1 on the second converted beam.

12. The method of claim 8, further comprising:
converting, by a half-waveplate, one of the first beam or the converted second beam to the second polarization.

13. The method of claim 8, wherein the first polarization is a horizontal polarization.

14. The method of claim 8, further comprising:
mixing the first beam and the converted second beam using a 50:50 beam splitter.

15. A system for generating a radially polarized laser beam, comprising:
a laser to emit a randomly polarized laser beam;
collimating optics to collimate the randomly polarized laser beam;
a passive optical filter comprising:
a first polarization beam splitter to separate the randomly polarized laser beam into a first beam with a first polarization and a second beam with a second polarization orthogonal to the first polarization,
an optical device to convert the second beam from the first polarization beam splitter to the first polarization and remove coherence between the second beam and the first beam,
a beam splitter to incoherently mix the first beam from the first polarization beam splitter and the converted second beam from the optical device,
a waveplate to convert one of the first beam from the beam splitter or the converted second beam from the beam splitter to the second polarization,
spiral optics to provide orbital angular momentum to the first beam from the beam splitter and the converted second beam from the waveplate,
a second polarization beam splitter to combine the first beam from the spiral optics and the converted second beam from the spiral optics to a combined beam, and
an optical plate to convert orthogonal polarization components in the combined beam to circular polarization components which co-axially superimpose to produce the radially polarized laser beam; and
focusing optics to focus the radially polarized laser beam.

16. The system of claim 15, wherein the optical device of the passive optical filter comprises a beam converter and at least one mirror mounted on a delay stage configured to ensure a path length difference between the first beam and the converted second beam exceeds a coherence length of the randomly polarized laser beam.

17. The system of claim 15, wherein the spiral optics of the passive optical filter comprise:
a first spiral phase plate receiving the first beam from the beam splitter; and
a second spiral phase plate receiving the second converted beam from the waveplate.

18. The system of claim 17, wherein the first spiral phase plate has a topological charge of +1 and the second spiral phase plate has a topological charge of −1.

19. The system of claim 15, wherein the waveplate of the passive optical filter is a half-wave plate, the first polarization is horizontal polarization.

20. The system of claim 15, wherein the beam splitter of the passive optical filter is a 50:50 beam splitter configured to produce two output beams of equal intensity.
